(19) United States
(12) Patent Application Publication
(10) Pub. No.: US 2013/0042288 A1
(43) Pub. Date: Feb. 14, 2013

(54) METHOD AND ARRANGEMENT FOR PLAYING OUT A MEDIA OBJECT

(71) Applicants: Niklas Fondberg, Enskede (SE); Mats Cedervall, Harnosand (SE); Johan Svedberg, Stockholm (SE)

(72) Inventors: Niklas Fondberg, Enskede (SE); Mats Cedervall, Harnosand (SE); Johan Svedberg, Stockholm (SE)

(73) Assignee: TELEFONAKTIEBOLAGET LM, Stockholm (SE)

(21) Appl. No.: 13/643,678

(22) PCT Filed: Apr. 26, 2010
(86) PCT No.: PCT/SE2010/050459

§ 371 Date: Oct. 26, 2012

(51) Int. Cl. H04N 21/643; G06F 15/16

(52) U.S. Cl. 725/109; 709/217

(57) ABSTRACT

A method and arrangement in a media equipment (300) for enabling instant and uninterrupted layout of a media object when selected by a user. The media equipment obtains (3:1) information on available bandwidth for media transfer and receives (3:2) references to a selection of offered media objects, e.g. from an IPlV server (302). The media equipment downloads and pre-buffers (3:4) opening parts of at least some of the media objects from one or more content servers (304) according to the available bandwidth for media transfer. A list of the offered media objects is displayed (3:5), and as soon as the user selects a pre-buffered media object from the displayed list, playout of the pre-buffered opening part of the selected media object is started (3:7). The remaining part of the media object is also downloaded (3:8) during continued playout. Thereby, the pre-buffered media objects can be played out immediately and without interruption, and still, not more than necessary media data can be pre-buffered at the media equipment.

### TECHNICAL FIELD

The invention relates generally to a method and arrangement for downloading and instant playing out of media content accessed from a content server in an IP network.

### BACKGROUND

In recent years, the concept of IPTV has been developed as an alternative or complement to traditional TV broadcasting. According to different IPTV services, a media object, e.g. a film, can be either streamed or downloaded from a content server in an IP network to a user's TV equipment such as an STB (Set Top Box). When streamed to a receiving TV equipment, the media object is played out as data is received, using a buffer mechanism to cater for slight variations in data throughput, also known as jitter. A media object can also be downloaded and stored as a media file, to be played out at some point typically after the complete file or at least some playable part of the file has been downloaded.

FIG. 1 illustrates schematically that a user's TV equipment 100 receives media data of a media object from a content server 102 by means of streaming. The received media data is played out on a media player 100a after being buffered temporarily in a buffer unit 100b. The buffer time is typically less than a few seconds. Further, FIG. 2 illustrates downloading of a media file to a user's TV equipment 200 from a content server 202. The received media file is thus first stored in a media storage 200b and can then at some point be played out on a media player 200a. It is then up to the user to delete the media file from the media storage 200b, if not made automatically by the TV equipment.

Different communication services are associated with different service or traffic classes for data transport in order to achieve a relevant Quality of Service (QoS) for each service. As indicated in FIG. 1, the streaming variant requires a certain QoS in terms of data throughput and latency in the transport network(s) between content server 102 and TV equipment 100, to achieve a data transfer rate reasonably matching a “nominal” playout rate in media player 100a.

On the other hand, the downloading variant typically uses a service or traffic class generally referred to as “best effort”, implying that the download rate is not critical and there is no guaranteed data throughput whatsoever, basically relying on what bandwidth is currently available in the transport networks after data sessions with higher priorities have been satisfied in the transport network(s). Nevertheless, it is typically possible to commence the playout from media storage 200b before the complete media file has been downloaded, as indicated above.

Using either of the mechanisms above, the user must wait after having selected a media object from a list of available media objects, until a session for media transfer from the content server 102, 202 has been established and at least some playable part of the media object has been transferred to the receiving TV equipment 100, 200. In the downloading case for example, during dense traffic in the transport network, it may take 30 minutes or even longer before playout of the selected media object can commence, which is of course disturbing if the user wants to enjoy the media object immediately.

Further, if the data transfer rate is slower than the nominal playout rate, all data in the buffer 100b or file storage 200b will eventually be consumed and the playout must be suspended in order to receive more media data to play out. It can be readily understood that any such disturbance of the user's enjoyment/experience of watching the media object, either by having to wait for the playout to start or by frequent interruptions during the playout, will reduce the performance quality from the user's perspective. For streaming services, this problem is typically addressed by using the above-mentioned QoS mechanisms which are on the other hand associated with certain costs.

US 2009/0046545 A1 discloses that pre-buffering of media files can be employed to improve the initial playback performance. Media items are presented in a list to the user, and when an “input focus device”, e.g. a mouse pointer, is located close to a media item in the list, that media item is pre-buffered up to a predetermined amount of data, in the event that the media item is then selected by the user. Playback of pre-buffered data of a selected media file is commenced while additional data is received.

### SUMMARY

It is an object of the invention to address at least some of the problems and issues outlined above. It is also an object to enable instant and uninterrupted playing of a selected media object when accessed and downloaded from a server in an IP network. It is possible to achieve these objects and others by using a method and an arrangement as defined in the attached independent claims.

According to one aspect, a method is provided in a media equipment for playout of a media object. In this method, the media equipment obtains information on available bandwidth for media transfer to the media equipment, and receives references to a selection of offered media objects, e.g. by means of a service of delivering media objects such as an IPTV service. Then, the media equipment pre-buffers opening parts of at least some of the media objects according to the available bandwidth for media transfer. The above actions can be performed automatically in a configuration procedure, e.g. when the media equipment is powered-on or otherwise activated for configuration.

At some point later, when an activation input is received from a user, the media equipment displays a list of the offered media objects. As soon as a pre-buffered media object is selected by the user from the list, the media equipment starts playout of the pre-buffered opening part of that media object. Further, the remaining part of the selected media object is also downloaded during continued playout of the selected media object. Thereby, the selected media object can be played out immediately and without interruptions, considering the available bandwidth, thanks to the pre-buffered opening part.

According to another aspect, an arrangement is provided in a media equipment that is configured to enable instant and uninterrupted playout of a media object. The media equipment comprises a media storage, a media player and a download manager. The download manager comprises an obtaining module adapted to obtain information on available bandwidth for media transfer to the media equipment, and a receiving module adapted to receive references to a selection of offered media objects. The download manager further comprises a downloading module adapted to download and pre-buffer opening parts of at least some of the media objects in the media storage according to the available bandwidth for media transfer.

The download manager also comprises a displaying module adapted to display a list of the offered media objects in response to an activation input from the user, and a playout module adapted to start playout of a pre-buffered opening part of a media object by the media player as soon as the media object is selected by the user. The downloading module is further adapted to download the remaining part of the selected media object during continued playout of the media object.

The above method and arrangement may be configured and implemented according to different embodiments. In one embodiment, the sizes of the opening parts of the media objects to pre-buffer are calculated based on the available bandwidth for media transfer, to enable uninterrupted playout of any of the pre-buffered media objects when selected by the user. Thereby, the sizes of the opening parts to pre-buffer can be optimised such that not more media data than necessary is pre-buffered before the user selects a media object, still enabling uninterrupted playout of any of the pre-buffered media objects when selected.

In another embodiment, each opening part size is calculated further based on the total playout duration and total data amount of the corresponding media object, such that the pre-buffering of each individual media object can be optimised. The number of media objects to pre-buffer may also be determined based on the calculated opening part sizes and on the available storage space in the media equipment.

The media equipment may obtain the available bandwidth either from a suitable node from which such information is available, or by adaptively determining the bandwidth used during the pre-buffering process. Further, earlier pre-buffered media objects may be deleted from the media storage before the pre-buffering. For example, the media equipment may be a TV equipment that obtains the above references and the list of offered media objects from an IPTV server and obtains the opening parts for pre-buffering from one or more content sewers.

Further possible features and benefits of this solution will become apparent from the detailed description below.

### BRIEF DESCRIPTION OF DRAWINGS

The invention will now be described in more detail by means of exemplary embodiments and with reference to the accompanying drawings, in which:

FIG. 1 is a schematic diagram illustrating how a media object can be streamed from a content sewer for playout at a user's TV equipment, according to the prior art.

FIG. 2 is a schematic diagram illustrating how a media object can be downloaded from a content server for playout at a user's TV equipment, according to the prior art.

FIG. 3 is a schematic diagram illustrating how a selection of media objects can be offered for instant playout at a user's TV equipment, according to an exemplary embodiment.

FIG. 4 is a flow chart with steps performed at a media equipment, according to another exemplary embodiment.

FIG. 4a is a modification of some of the flow chart in FIG. 4, according to another exemplary embodiment.

FIG. 5 is a schematic diagram illustrating three scenarios with different available bandwidth where the solution can be employed.

FIG. 6 is a block diagram illustrating in more detail an arrangement in a media equipment, according to further exemplary embodiments.

FIG. 7 is a signaling diagram illustrating a more detailed example of how the invention can be put into practice, according to further exemplary embodiments.

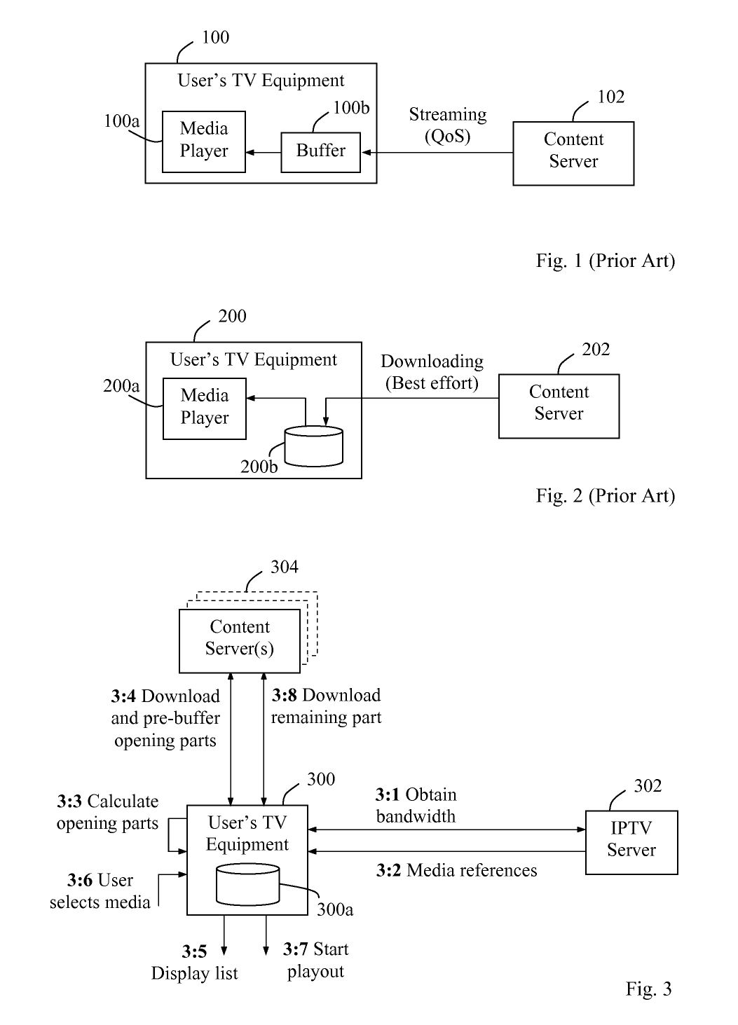

### DETAILED DESCRIPTION

Briefly described, a solution is provided to enable instant and uninterrupted playout of a media object on a media equipment as soon as the user has selected the media object. This is achieved by pre-buffering an opening part of a selection of media objects in the media equipment in an automatic configuration procedure or the like, that is, well before they are offered to the user for consumption and the user can make his/her selection of a particular media object. Thereby, playout of the media object can start immediately when the user has selected the media object by playing out the pre-buffered opening part and at the same time downloading the remaining part of the media object for subsequent playout. In this description, the term “media object” refers to any content comprising media either in a video format, such as movies and TV programs, or in a pure audio format such as music.

Further, the size of the opening part of each offered media object to pre-buffer is calculated based on what bandwidth is available for media transfer to the receiving user's media equipment and on the total duration and size of the media object, such that playout of the media object can be completed before all received data has been consumed from the buffer or other storage, i.e. uninterrupted playout. Thereby, a quantity of received data will always be available in the buffer or storage for playout and the user's enjoyment of watching or listening to the media object will not be disturbed by any interruptions during the playout.

An exemplary communication scenario with different actions performed when using this solution in the context of a TV service, will now be described with reference to FIG. 3. It should be noted that each action shown in this figure may involve one or more messages transmitted between the shown nodes, depending on the communication protocols and mechanisms used. A TV equipment 300 operated by a user is shown, which may be any TV apparatus, e.g. an STB, capable of receiving media data of media objects from one or more content servers 304 and storing received media data in a media storage 300a. However, the invention is further not limited to TV services and any type of media equipment may be used in the manner described here, depending on the service application.

The media data may be received by using a downloading-type mechanism, although the invention is not limited to any particular data transfer technique. In either case, the term “downloading” will be used in this description for simplicity to generally indicate fetching of media data from a content server. However, the media storage 300a in TV equipment 300 should have capacity for storing enough amounts of media data to accomplish this solution, which typically far exceeds the buffering of data in conventional streaming buffers. The TV equipment 300 is also capable of playing out received and stored media objects. In particular, the playout of an initial section of a media object can commence at the same time as further media data of the remainder is received and stored until the complete media object has been received and played out.

An IPTV server 302 is also shown which is used for providing and controlling an IPTV service, including offering a selection of media objects to the user, while the actual media data is downloaded from the content server(s) 304. However, the invention is not limited to IPTV services but can be used for any services of providing media objects for playout on a user's equipment. In this solution, an opening part of at least some of a selection of media objects is pre-buffered in TV equipment 300 during an automatic configuration procedure, e.g. when the equipment 300 is powered-on or otherwise activated for configuration.

In order to know what size of each media object's opening part to pre-buffer to ensure uninterrupted playout if selected by the user, it is determined what bandwidth is available to the TV equipment 300 for data transfer from the content server(s) 304 to download a remaining part of the selected media object. Information on the available bandwidth may be obtained from a suitable node from which such information is available, or by measuring the actual data transfer rate during the pre-buffering. The data transfer rate is thus directly dependent on the bandwidth used during the data transfer. If the data transfer rate is lower than the nominal playout rate, a certain amount of media data of a media object must be pre-buffered to be played out at the same time the remaining part of the media object is downloaded for continued playout, such that there will always be data in the media storage 300a to play out or “consume”.

In a first shown action 3:1, the TV equipment 300 obtains its available bandwidth from the IPTV server 302, or from any other suitable information source that can provide bandwidth information to the TV equipment 300, e.g. a node controlled by a network operator. In this example, the IPTV server 302 is able to acquire such bandwidth information on connected subscribers from a network service node, not shown, e.g. a so-called “AAA” (Authentication, Authorisation, Accounting) server typically employed in access networks. Alternatively, the available bandwidth may be obtained adaptively by determining the actual data rate during the pre-buffering in a later action.

The TV equipment 300 also receives references to a selection of media objects which are offered from the IPTV server 302, e.g. as part of an IPTV service, in a next action 3:2. It should be noted that actions 3:1 and 3:2 are basically independent of each other and could just as well be made in the reverse order. The media references may be in a URL (Universal Resource locator) format or any other suitable format which the TV equipment 300 can use for accessing and downloading the corresponding media objects from the content server(s) 304. For example, IPTV server 302 may send a list of URLs to TV equipment 300 referring to media objects that may have been chosen for the user according to a predefined profile or preferences. Thus, the offered selection of media objects may be “personalised” and basically adapted to the receiving user. However, the offered media objects according to this URLlist are not presented to the user at this point, instead being part of an automatic configuration procedure as mentioned above.

In a further action 3:3, the TV equipment 300 calculates, based on the obtained bandwidth, the amount of media data of each offered media object that should be pre-buffered as an opening part of the media object in order to enable uninterrupted playout as a remaining part is downloaded, if that media object is selected by the user. It should be noted that the required opening part of different media objects may be of different sizes depending on the total playing time and size of the media objects, i.e. the total data amount to download. The amount of media data of each offered media object that should be pre-buffered to ensure uninterrupted playout should thus be calculated depending on available bandwidth, and also on the total playing time and size/data amount of the media objects.

Further, it may first be checked how much storage space is available in the media storage 300a, possibly after deleting any previously pre-buffered media data not needed according to the received URLlist. Hence, there may not be mom for pre-buffering opening part of all the offered media objects, although it is assumed that at least some of them can be pre-buffered. It should further be noted that actions 3:1 and 3:3 may alternatively be executed in an adaptive manner during the downloading and pre-buffering below.

TV equipment 300 accordingly executes the downloading and pre-buffering of the opening parts of at least some of the offered media objects according to the received corresponding media references, in a following action 3:4. The media objects may be accessible from the one or more content servers 304 by means of the previously received media references, e.g. URLs, in a conventional manner which is not necessary to describe here further to understand the present solution. Thus, different media objects may be accessible from different content servers or from one and the same content server, and the invention is not limited in this respect.

Since the opening parts are downloaded from the content server(s) 304 and pre-buffered in the media storage 300a automatically in a configuration procedure according to the above-described actions, it can be assumed that the downloading and pre-buffering operation is finished, more or less, before the selection of media objects are presented to the user as being selectable for playout, which will be described below. Thereby, playout can commence immediately once the user selects a pre-buffered media object at the same time as the remainder of that media object, referred to as the remaining part, is downloaded for continued and uninterrupted playout.

Thus, upon some suitable activation command from the user, such as starting an IPTV application on the TV equipment 300, a list or the like with the selection of media objects is displayed and presented to the user as being selectable for playout, as shown in a next action 3:5. For example, if not all offered items in the list have been pre-buffered, e.g. due to lack of storage space in TV equipment 300, the pre-buffered media objects may be marked in the list with a label “immediate playout” or similar, while the ones not being pre-buffered can be marked with a label “delayed playout” or similar. It should be noted that this action may be performed some time after finishing the configuration procedure of actions 3:1-3:4.

A next action 3:6 illustrates that the user at some point select one of the offered media objects from the list, and playout of the selected media object is then started immediately, in a following action 3:7, by playing out the pre-buffered opening part. More or less at the same time, the TV equipment 300 establishes a session for media transfer of the remaining part of the media object from the content server 304 holding that media object, which is accordingly downloaded in a following action 3:8 for continued playout of the complete media object.

Thereby, the entire media object can be played out as soon as it is selected by the user and without any disturbing interruptions since there will always be media data to play out from the media storage 300a as the size of the opening part was calculated according to the obtained information on available bandwidth for media transfer to TV equipment 300. If the available storage space allows for pre-buffering of all the offered media objects, this solution will enable immediate and uninterrupted playout of any media object in the list. In particular, the size of the pre-buffered opening part can be optimised for uninterrupted playout, given the available bandwidth and length/size of the complete media object, such that a sufficient but not more than necessary amount of media data is pre-buffered. Preferably, a surplus marginal of media data may be pre-buffered in action 3:4 to cater for any variations in the media transfer rate that may occur when downloading the remaining part.

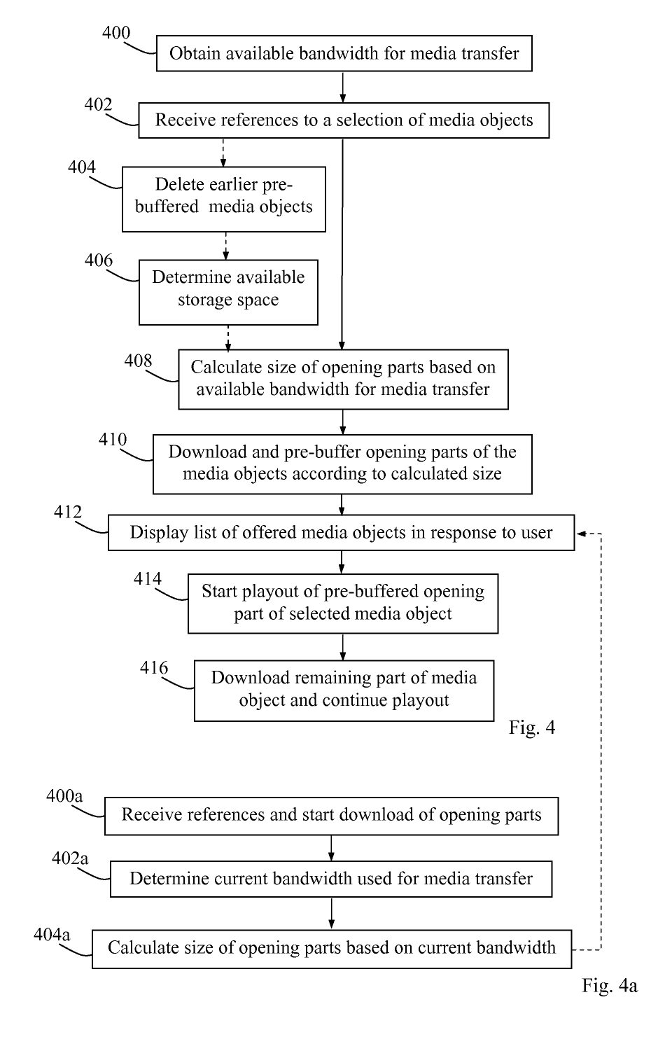

A procedure for playout of a media object in a media equipment that comprises a media storage, will now be described with reference to the flow chart in FIG. 4. The shown procedure actions are basically performed at the media equipment, e.g. the TV equipment 300 in the above-described example, and not necessarily in the shown sequence order depending on the implementation. In a first action 400, the media equipment obtains information on available bandwidth for media transfer to the media equipment, e.g. from an IPTV server or other operator-controlled service node, basically corresponding to action 3:1 above.

The media equipment also receives references to a selection of offered media object in a next shown action 402, e.g. references in the URLformat, from a server that generally provides a service of supplying media objects to users, such as an IPTV server, basically corresponding to action 3:2 above. In an optional action 404, the media equipment may check if the media storage holds any previously pre-buffered media objects, i.e. the opening part thereof, and delete any such objects from the storage which are not included amongst the received media references. Alternatively, the media equipment may operate to delete any pre-buffered media objects from the media storage automatically, e.g. after a preset expiry time.

In a further optional action 406, the media equipment may determine how much storage space is available in the media storage if critical for the pre-buffering to follow. Next, in a further action 408, the media equipment calculates the size of the opening part of each media object to pre-buffer to enable uninterrupted playout, based on at least the available bandwidth for media transfer obtained in action 400, basically corresponding to action 3:3 above. As indicated above, the opening part sizes may be calculated to optimise the pre-buffering in terms of uninterrupted playout and occupied storage space. Further, the opening part sizes may be calculated separately for different media objects further depending on their individual playing lengths and total sizes/data amounts.

The media equipment then downloads and pre-buffers an opening part of at least some of the media objects according to available bandwidth for media transfer, in a following action 410, basically corresponding to action 3:4 above. The media object opening parts are thus downloaded from one or more content sewers holding these media objects. As mentioned earlier, the number of media objects to pre-buffer from the received reference selection may be determined depending on how much storage space is currently available in the media storage as determined in the optional action 406 above. Action 410 basically completes the configuration part of the procedure.

At some point later, the user inputs a command to activate a service of providing media objects for playout on the media equipment, and the media equipment then displays a list of the offered media objects in response to the activation input, in an action 412, basically corresponding to action 3:5 above. In this action, the offered media objects may be marked in the displayed list as being available for immediate playout or delayed playout, depending on whether they have been pre-buffered or not.

As soon as the user selects one of the offered and pre-buffered media objects from the list, playout of the pre-buffered opening part of that media object is started immediately, in a following action 414, basically corresponding to action 3:7 above. More or less at the same time, the media equipment downloads the remaining part of the selected media object from the content server holding that media object, in an action 416, and is able to continue the playout without interruptions until the complete media object has been downloaded and played out.

As mentioned above, the available bandwidth may be determined in an adaptive manner at the same time the downloading of media object opening park is ongoing. FIG. 4a illustrates a somewhat modified version of the configuration part of the procedure that can be used as a variant of the above-described actions 400-410. However, actions 404 and 406 are omitted in the below description of this modified version, even though they may be performed as well.

In a first action 400a of this modified version, references to the selection of media objects are received, which basically corresponds to action 402 above, and the media transfer and download of an opening part of at least one of the media objects in the selection is started. During this downloading, the current bandwidth used for the media transfer is determined in an action 402a, e.g. by measuring the media transfer rate when downloading media data, which basically corresponds to action 400 above. Then, the size of the opening part of each media object to pre-buffer is calculated in an action 404a, based on the available bandwidth for media transfer obtained in action 402a, to enable uninterrupted playout according to the user-controlled part of the procedure which may follow from action 404a continuing with actions 412-416 as indicated by the dashed arrow.

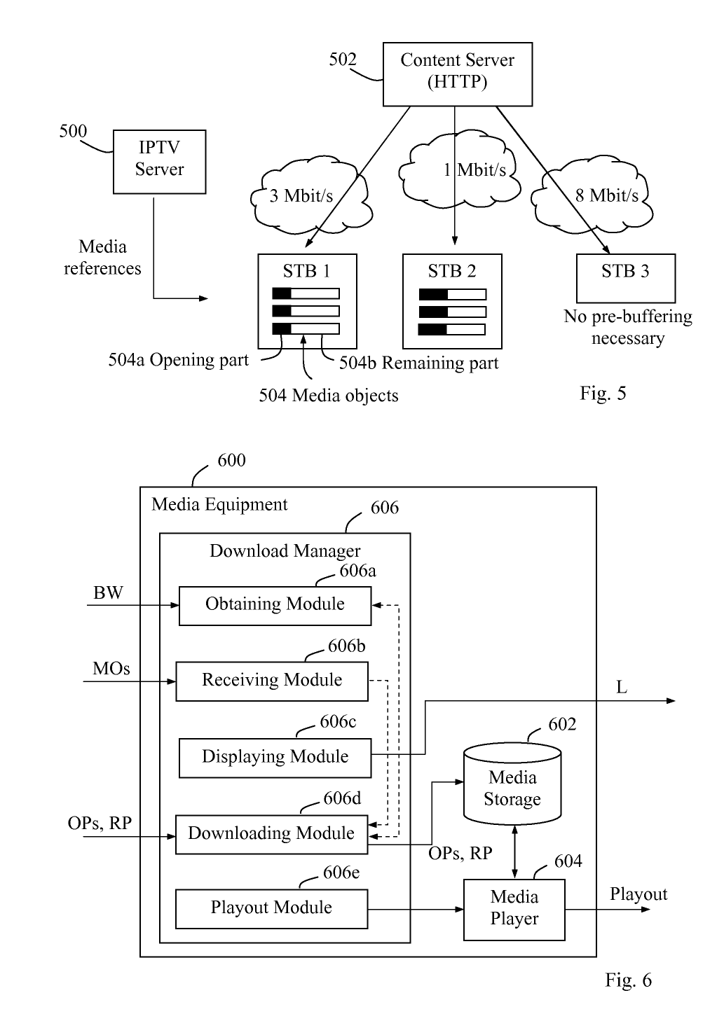

In FIG. 5, a scenario using the present solution is illustrated where three STBs 1-3, all using an IPTV service from an IPTV server 500, have different available bandwidths for media transfer of media object files over their respective transport networks from a content server 502. The figure illustrates that the IPTV server 500 provides references to a selection of offered media objects to the STBs 1-3, assuming that all STBs 1-3 are offered the same media objects for simplicity. The calculated necessary opening parts and resulting remaining parts of the media files for uninterrupted playout are schematically illustrated as black and white fields, respectively, in the STBs. For simplicity, it is assumed that the media files are of equal length and size which in reality would not typically be the case.

In this example, STB 1 has a bandwidth of 3 Megabits per second, STB 2 has a bandwidth of 1 Megabit per second, while STB 3 has a bandwidth of 8 Megabits per second in their respective networks. This implies that STB 1 needs to download and pre-buffer a certain size of the opening part of the media files in relation to their total lengths, i.e. in terms of duration and data amount, while STB 2 needs to download a relatively greater size of the corresponding opening part to ensure uninterrupted playout, due to a lower available bandwidth, as indicated by the black fields being of different lengths in STB 1 and STB 2. Having the “best” bandwidth of the three, STB 3 needs not pre-buffer any opening part at all for uninterrupted playout of a media object when selected, provided that the nominal playout rate of these media objects does not exceed the available bandwidth of 8 Megabits per second. As mentioned above, the media files and the calculated necessary opening parts thereof may typically be of different sizes and/or nominal playout rates, e.g. depending on total duration/data amount, encoding format and resolution.

An arrangement in a media equipment controlled by a user will now be described in more detail with reference to the block diagram in FIG. 6. The media equipment 600 may be used to accomplish any of the above-described procedures and embodiments and thus corresponds to the TV equipment 300 in the example of FIG. 3. Various functional entities therein are called “modules” in this description, although they could also be seen as unit, blocks, elements, component, as for example. The media equipment 600 is configured for playout of a media object downloaded from a content server or the like, when using a service of generally supplying media objects to users, e.g. provided by an IPTV server.

The media equipment 600 comprises a media storage 602 in which downloaded media objects can be stored as media files, a media player 604 capable of playing out media objects from the media storage 602, and a download manager 606 with a number of functional modules configured as follows. The download manager 606 comprises an obtaining module 606a adapted to obtain information on available bandwidth BW for media transfer to the media equipment, which may be done as described above for action 400 in FIG. 4 or as described above for action 402a in FIG. 4a.

The download manager 606 further comprises a receiving module 606b adapted to receive references to a selection of offered media objects MOs, e.g. from an IPTV server or the equivalent. Download manager 606 also comprises a displaying module 606c adapted to display a list L of the offered media objects in response to an activation input, and a downloading module 606d adapted to download and pre-buffer an opening part of at least some of the media objects OPs in the media storage according to available bandwidth for media transfer. Download manager 606 also comprises a playout module 606e adapted to start playout of a pre-buffered opening part of a media object by the media player as soon as that media object is selected by the user, e.g. by triggering the media player 604 to play out the pre-buffered opening part from media storage 602. The downloading module 606d is further adapted to download the remaining part of the selected media object RP during continued playout of the media object.

The download manager 606 may be further configured according to different exemplary embodiments. In one embodiment, the downloading module 606d is adapted to calculate the sizes of the opening parts of the media objects based on the available bandwidth for media transfer to enable uninterrupted playout of any of the media objects when selected by the user. In another embodiment, the downloading module 606d is adapted to calculate each opening part size further based on the total playout duration and/or the total data amount of the corresponding media object.

In further, the downloading module 606d may also be adapted to determine the number of media object to pre-buffer based on the calculated opening part sizes and on the available storage space in the media equipment. The obtaining module 606a may also be adapted to determine the available bandwidth for media transfer adaptively during the pre-buffering, e.g. by measuring the data transfer rate when downloading at least one of the media object opening parts.

In further examples, the downloading module 606d may be adapted to delete earlier pre-buffered media objects from the media storage before the pre-buffering, and the displaying module 606c may also mark the offered media objects in the displayed list as being available for immediate playout or delayed playout, depending on whether they have been pre-buffered or not.

As in the examples described above, the media equipment 600 may be a TV equipment that obtains the references of offered media objects from an IPTV server and obtains the opening part for pre-buffering from one or more content servers. In that case, the list of offered media objects can also be obtained from the IPTV server.

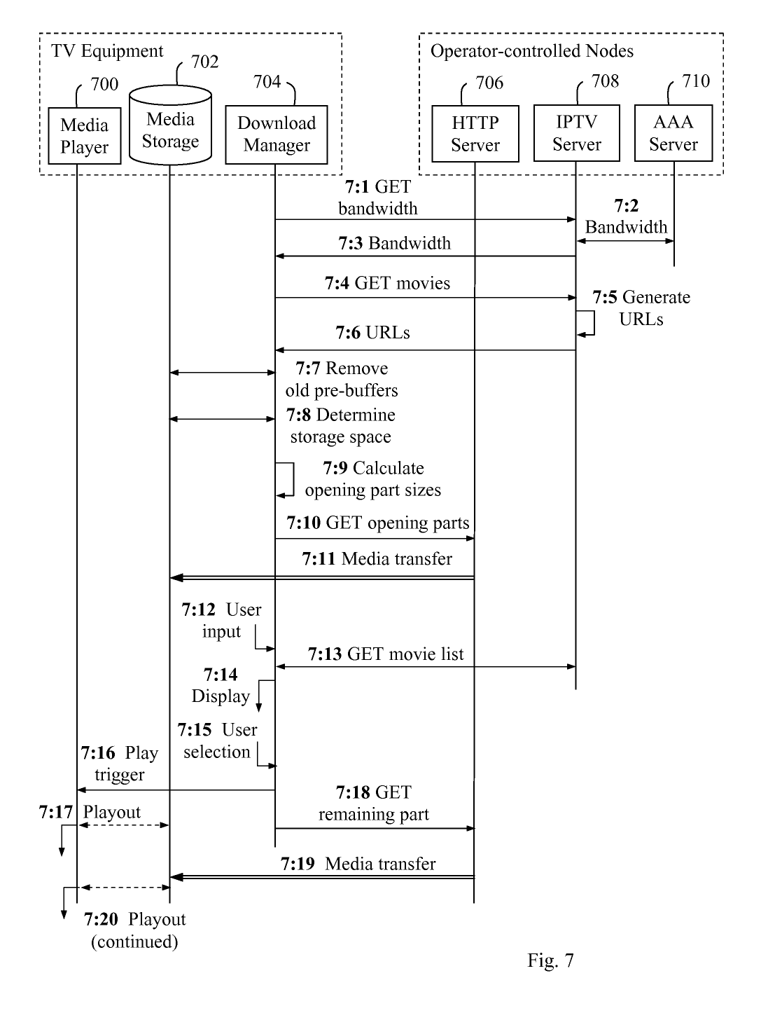

It should be noted that FIG. 6 merely illustrates various functional modules or units in the media equipment 600 in a logical sense, although the skilled person is able to implement these functions in practice using suitable software and hardware means. Thus, the invention is generally not limited to the shown structures of the media equipment 600, while the download manager 606 therein and its functional modules 606a-e may be configured to operate according to the methods and procedures described for FIGS. 3-5 above and FIG. 7 below, where appropriate.

An example of how the inventive solution can be implemented in practice will now be described with reference to the signaling diagram in FIG. 7. In this example, a user's TV equipment comprises a media player 700, a media storage 702 and a download manager 704. The following operator-controlled nodes are also involved in this example: an HTTP server 706 from which media objects can be downloaded, an IPTV server 708 and an AAA server 710 from which information on available bandwidth can be obtained. The HTTP server 706 thus corresponds to the content server(s) described in the previous examples above. The AAA server 710 is just one possible example of a source for bandwidth information and the solution is not limited thereto.

The procedure in FIG. 7 will now be described in terms of different schematic steps or actions, each of which may represent one or more specific functions and messages transferred back and forth depending on the protocols used. A first action 7:1 illustrates that download manager 704 sends a request for bandwidth information to IPTV server 708 which in turn fetches the available bandwidth of the TV equipment from the AA server 710, in an action 7:2 and returns the results to download manager 704 in another action 7:3.

A next action 7:4 illustrates that download manager 704 sends a request to IPTV server 708 for movies available according to the IPTV service used. IPTV server 708 then generates a list of URLs, in a next action 7:5, as references to a selection of offered media objects, in this case movies, and the URLlist is provided to the download manager 704 in a following action 7:6. The URLlist and corresponding selection of offered media objects may be adapted, or personalised, to the requesting TV equipment, e.g. according to preferences and/or a profile defined for an IPTV service subscription used.

In a next action 7:7, download manager 704 removes or deletes any previously pre-buffered media data not needed according to the received URLlist, from the media storage 702. Download manager 704 also determines what storage space is available for pre-buffering in media storage 702, in a further action 7:8. It should be noted that actions 7:7 and 7:8 may not be necessary, e.g. if the storage space is amply sufficient and always can accommodate pre-buffered media object files.

Next, download manager 704 calculates, in a next action 7:9, the sizes of the opening parts of the media objects in the list, based on the obtained bandwidth information, to enable uninterrupted playout of any of the offered media objects when selected by the user. In a next action 7:10, download manager 704 requests the opening parts of at least some of the media objects in the list from the HTTP server 706 as calculated, which are accordingly downloaded to media storage 702 in a media transfer action 7:11. This action completes the automatic configuring part of the procedure.

At some point later, the user activates the IPTV service in the TV equipment by some suitable input reaching the download manager 704 in action 7:12. In response thereto, download manager 704 fetches a list of available movies from IPTV server 708 in action 7:13, and displays the list as offered media objects, in this case a selection of movies, in a following action 7:14. When the user selects one of the offered movies from the list in a next action 7:15, the download manager 704 triggers the media player 700 to instantly start playout of the pre-buffered opening part of the selected movie, in a further action 7:16, such that the media player 700 begins to play out the movie from media storage 702 inaction 7:17.

More or less at the same time, download manager 704 sets up a media session by requesting the remaining part of the selected movie from HTTP server 706 in a further action 7:18, which is accordingly downloaded to media storage 702 in another action 7:19. Thereby, the playout of the movie from storage 702, first the pre-buffered opening part and then the remaining part, can continue uninterrupted in a final shown action 7:20, since the pre-buffered opening part was calculated to be sufficient, considering the available bandwidth, to avoid the media storage from becoming empty of media data during the entire playout.

In the above examples, the media references have been URLs, although they can be in any other useful format and the invention is not limited to any particular format of the media references. Further, the requesting messages shown in actions 7:1, 7:4, 7:10, 7:13 and 7:18 in FIG. 7 are indicated as a standard “HTTP GET” message, although the invention is not limited to this particular message or protocol.

While the invention has been described with reference to specific exemplary embodiments, the description is generally only intended to illustrate the inventive concept and should not be taken as limiting the scope of the invention. The invention is defined by the appended claims.

1. A method in a media equipment (300) for playout of a media object, comprising the following steps:
obtaining (400) information on available bandwidth for media transfer to said media equipment,
receiving (402) references to a selection of offered media objects,
pre-buffering (410) opening parts of at least some of said media objects according to the available bandwidth for media transfer,
displaying (412) a list of said offered media objects in response to an activation input,
starting playout (414) of a pre-buffered opening part of a media object as soon as that media object is selected by a user, and
downloading (416) the remaining part of the selected media object during continued playout of said media object.

2. A method according to claim 1, wherein the sizes of the opening parts (504a) of said media objects (504) are calculated (408) based on the available bandwidth for media transfer to enable uninterrupted playout of any of said media objects when selected by the user.

3. A method according to claim 2, wherein each opening part size (504a) is calculated further based on the total playout duration and total data amount of the corresponding media object.

4. A method according to claim 2 or 3, wherein the number of media objects (504) to pre-buffer is determined based on said calculated opening part sizes (504a) and on the available storage space (300a, 602, 702) in the media equipment.

5. A method according to any of claims 1-4, wherein the available bandwidth for media transfer is determined adaptively (402a) during said pre-buffering.

6. A method according to any of claims 1-5, wherein earlier pre-buffered media objects are deleted (404) from a media storage (300a, 602, 702) in the media equipment before said pre-buffering.

7. A method according to any of claims 1-6, wherein said offered media objects in the displayed list are marked (412) as being available for immediate playout or delayed playout, depending on whether they have been pre-buffered or not.

8. A method according to any of claims 1-7, wherein the media equipment (300) is a TV equipment that obtains said references of offered media objects from an IPTV server (302) and obtains said opening parts for pre-buffering from one or more content servers (304).

9. A method according to claim 8, wherein the list of offered media objects is obtained from said IPTV server.

10. An arrangement in a media equipment (600) for playout of a media object, comprising:
a media storage (602),
a media player (604), and
a download manager (606), comprising:
an obtaining module (606a) adapted to obtain information on available bandwidth (BW) for media transfer to said media equipment,
a receiving module (606b) adapted to receive references to a selection of offered media objects (MOs),
a downloading module (606d) adapted to download and pre-buffer opening parts of at least some of said media objects (OPs) in the media storage according to available bandwidth for media transfer,
a displaying module (606c) adapted to display a list (L) of said offered media objects in response to an activation input, and
a playout module (606e) adapted to start playout of a pre-buffered opening part of a media object by the media player as soon as the media object is selected by a user,
wherein the downloading module (606d) is further adapted to download the remaining part of the selected media object (RP) during continued playout of said media object.

11. An arrangement according to claim 10, wherein the downloading module (606d) is further adapted to calculate the sizes of the opening parts of said media objects based on the available bandwidth for media transfer to enable uninterrupted playout of any of said media objects when selected by the user.

12. An arrangement according to claim 11, wherein the downloading module (606d) is further adapted to calculate each opening part size further based on the total playout duration and/or the total data amount of the corresponding media object.

13. An arrangement according to claim 11 or 12, wherein the downloading module (606d) is further adapted to determine the number of media objects to pre-buffer based on said calculated opening part sizes and on the available storage space in the media equipment.

14. An arrangement according to any of claims 10-13, wherein the obtaining module (606a) is further adapted to determine the available bandwidth for media transfer adaptively during said pre-buffering.

15. An arrangement according to any of claims 10-14, wherein the downloading module (606d) is further adapted to delete earlier pre-buffered media objects from the media storage before said pre-buffering.

16. An arrangement according to any of claims 10-15, wherein the displaying module (606c) is further adapted to mark said offered media objects in the displayed list as being available for immediate playout or delayed playout, depending on whether they have been pre-buffered or not.

17. An arrangement according to any of claims 10-16, wherein the media equipment (300) is a TV equipment that obtains said references of offered media objects from an IPTV server (302) and obtains said opening parts for pre-buffering from one or more content servers (304).

18. An arrangement according to claim 17, wherein the list of offered media objects is obtained from said IPTV server (302).
